(19) United States
(12) Patent Application Publication
(10) Pub. No.: US 2024/0412448 A1
(43) Pub. Date: Dec. 12, 2024

(54) OBJECT RENDERING

(71) Applicant: SENSETIME GROUP LIMITED, Shatin, N.T. Hong Kong (CN)

(72) Inventors: Junyi LIN, Hong Kong (CN); Wei CHENG, Hong Kong (CN); Wenyan WU, Hong Kong (CN); Su XU, Hong Kong (CN); Jingtan PIAO, Hong Kong (CN); Chen QIAN, Hong Kong (CN); Hongsheng LI, Hong Kong (CN)

(21) Appl. No.: 18/206,393

(22) Filed: Jun. 6, 2023

(30) Foreign Application Priority Data
Apr. 6, 2022 (CN) 202210360321.7

(51) Int. Cl. G06T 15/20; G06T 7/73; G06T 15/08; G06T 15/50

(52) U.S. Cl. CPC G06T 15/205; G06T 7/75; G06T 15/08; G06T 15/503; G06T 2200/04

(57) ABSTRACT

An object rendering method includes: obtaining a parameterized model corresponding to a to-be-rendered object; based on a target viewpoint, determining multiple spatial points in a three-dimensional space corresponding to the parameterized model; for each of the multiple spatial points, for each of the multiple source viewpoints, based on position information of the spatial point, the parameterized model and the multiple original images, generating a target feature vector corresponding to the spatial point and matching the source viewpoint; and based on multiple target feature vectors corresponding to the spatial point and candidate color information of a projection point of the spatial point on each of the multiple original images, generating volume density and target color information corresponding to the spatial point; and based on volume densities and target color information respectively corresponding to the multiple spatial points, generating a rendered image of the to-be-rendered object under the target viewpoint.

### CROSS REFERENCE TO RELATED APPLICATIONS

This application claims priority to Chinese Patent Application No. 202210360321.7, filed on Apr. 6, 2022, the entire content of which is incorporated herein by reference.

### TECHNICAL FIELD

The present disclosure relates to the technical field of computer vision, in particular to methods and apparatuses, and electronic devices and storage media for object rendering.

### BACKGROUND

With the advancement of technology, free-view video is widely used in scenarios such as cinematography, three-dimensional immersive communication, augmented reality (AR), and virtual reality (VR).

Generally, the generation environment of free-view-video is more complex, such as the generation environment requires a professional photography environment, more shooting viewpoints, etc., which makes the generation of free-view video more difficult.

### SUMMARY

In view of this, in the present disclosure, object rendering methods and apparatuses, and electronic devices and storage media are provided.

In a first aspect, the present disclosure provides an object rendering method including: obtaining a parameterized model corresponding to a to-be-rendered object, w % here the parameterized model is constructed from pre-obtained multiple original images, and the multiple original images are images of the to-be-rendered object respectively captured at different multiple source viewpoints; based on a target viewpoint, determining multiple spatial points in a three-dimensional space corresponding to the parameterized model; for each of the multiple spatial points, for each of the multiple source viewpoints, based on position information of the spatial point, the parameterized model and the multiple original images, generating a target feature vector corresponding to the spatial point and matching the source viewpoint, where the target feature vector includes a visual feature of the spatial point at the corresponding source viewpoint; and based on multiple target feature vectors corresponding to the spatial point and candidate color information of a projection point of the spatial point on each of the multiple original images, generating volume density and target color information corresponding to the spatial point, and based on volume densities and target color information respectively corresponding to the multiple spatial points, generating a rendered image of the to-be-rendered object under the target viewpoint.

In the above method, the original images of the to-be-rendered object from multiple source viewpoints are used to generate a rendered image of any target viewpoint. The rendering process does not need to rely on a professional photography environment, and the rendering process is more stable and more efficient. In the present disclosure, a parameterized model corresponding to the to-be-rendered object is used. The parameterized model is a model representing the geometry of the pose of the to-be-rendered object, and using this parameterized model can generalize any unknown human body and unknown human body pose; and the parameterized model is generated by determining the model parameters through multiple original images. Compared with the way to get a three-dimensional model of human body by using a depth camera or other geometric scanner to model the human body in three-dimensional, the process of establishing the parameterized model in the present disclosure focuses on the pose of the to-be-rendered object, without the need to pay attention to other information unrelated to the pose such as clothing information, hair information, etc. The method of determining the parameterized model is more efficient and simple.

At the same time, in the present disclosure, the parameterized model and the position information of the spatial point are used to determine the target feature vector corresponding to the spatial point matching each of the source viewpoints, such that the implicit geometric features of the spatial point relative to the parameterized model can be embedded into the target feature vector, and the target feature vector can present the features of the pose of the to-be-rendered object. The position information of the spatial point and the original images are used, such that the visual features in the original images can be embedded into the target feature vector. The visual features include, for example, the clothing features and external decoration features of the to-be-rendered object, such that the target feature vector can represent the clothing and external decoration features of the to-be-rendered object. The multiple target feature vectors corresponding to the spatial point and candidate color information of a projection point of the spatial point on each of the multiple original images are used to determine volume density and target color information corresponding to the spatial point more accurately. The volume densities and color information respectively corresponding to multiple spatial points are used to generate a rendered image of the to-be-rendered object from the target viewpoint more accurately, the generated rendered image has better image quality.

In a possible embodiment, based on the position information of the spatial point, the parameterized model and the multiple original images, generating the target feature vector corresponding to the spatial point and matching the source viewpoint includes: based on the position information of the spatial point and the parameterized model, generating a first feature vector corresponding to the spatial point, where the first feature vector is configured to represent an implicit geometric feature between the spatial point and the parameterized model; based on the position information of the spatial point and an original image corresponding to the source viewpoint, generating a second feature vector corresponding to the source viewpoint, where the second feature vector is configured to represent a visual feature for the spatial point in the original image corresponding to the source viewpoint; and based on at least one of the first feature vector, the second feature vector corresponding to the source viewpoint, the position information of the spatial point or a direction vector corresponding to the target viewpoint, generating a target feature vector corresponding to the spatial point and matching the source viewpoint.

Here, the first feature vector configured to represent an implicit geometric feature between the spatial point and the parameterized model and the second feature vector configured to represent a visual feature for the spatial point on the original image corresponding to the source viewpoint are generated. And using at least one of the first feature vector, the second feature vector corresponding to each source viewpoint, the position information of the spatial point or a direction vector corresponding to the target viewpoint, a target feature vector corresponding to the spatial point and matching each source viewpoint is generated more flexibly.

In a possible embodiment, based on the position information of the spatial point and the parameterized model, generating the first feature vector corresponding to the spatial point includes: based on the position information of the spatial point, determining a target model point on the parameterized model with the smallest distance under the spatial point; based on the position information of the spatial point and position information of the target model point, determining distance information and direction information of the spatial point relative to the parameterized model; based on a mapping relationship between a first model point on the parameterized model and a second model point on a canonical model, determining position information of the second model point corresponding to the target model point; and based on at least one of the distance information, the direction information or the position information of the second model point corresponding to the target model point, generating the first feature vector corresponding to the spatial point.

Here, by determining the first feature vector corresponding to the spatial point, which is configured to represent the implicit geometric features between the spatial point and the parameterized model, an implicit geometric estimation of the parameterized model is realized, such that when the target feature vector is generated using the first feature vector, the target feature vector has the geometric features of the parameterized model, and thus the target feature vector can be subsequently used to more accurately determine volume density and target color information of the spatial point, improving the accuracy of the rendered image.

In a possible embodiment, based on the position information of the spatial point and the original image corresponding to the source viewpoint, generating the second feature vector corresponding to the source viewpoint includes: generating a visual feature map for the original image corresponding to the source viewpoint, by performing feature extraction on the original image; based on the position information of the spatial point and camera parameter information corresponding to the original image, determining feature information of a target feature point on the visual feature map corresponding to the spatial point, and based on the feature information of the target feature point, generating the second feature vector corresponding to the source viewpoint.

Here, by determining the second feature vector corresponding to each source viewpoint, which is used to represent the image features of the spatial point on the original image corresponding to the source viewpoint, such that when a target feature vector is generated by using the second feature vector, the target feature vector has the attribute features of the to-be-rendered object, such as clothing and hairstyle, and thus the volume density and the target color information of the spatial point can be more accurately determined by using the target feature vector, which improves the accuracy of the rendered image.

In a possible embodiment, based on the multiple target feature vectors corresponding to the spatial point and the candidate color information of the projection point of the spatial point on each of the multiple original images, generating the volume density and the target color information corresponding to the spatial point includes: generating intermediate feature data corresponding to each of the multiple source viewpoints, by performing feature extraction on each of the multiple target feature vectors; based on the intermediate feature data corresponding to the multiple source viewpoints, generating the volume density and predicted color information corresponding to the spatial point; and based on the predicted color information and the candidate color information of the projection point of the spatial point on each of the multiple original images, generating the target color information corresponding to the spatial point.

Considering that when the number of source viewpoints is small, there is a situation where the spatial point is occluded from each source viewpoint. In this situation, if the candidate color information corresponding to the spatial point is blended, it causes a large error in the obtained target color information, and the robustness is poor. In order to alleviate the above problem, intermediate feature data corresponding to each source viewpoint can be used to generate the predicted color information corresponding to the spatial point. Such that the blending parameters, the predicted color information and multiple pieces of candidate color information can be subsequently used to generate the target color information corresponding to the spatial point more accurately.

In a possible embodiment, based on the predicted color information and the candidate color information of the projection point of the spatial point on each of the multiple original images, generating the target color information corresponding to the spatial point includes: determining blending parameters corresponding to the predicted color information and the candidate color information corresponding to each of the multiple original images, where the blending parameters include at least one of: a first parameter representing visibility of the spatial point from a corresponding source viewpoint, or a second parameter representing a weight of color information; and generating the target color information corresponding to the spatial point, by performing a blending process on the predicted color information and the candidate color information corresponding to each of the multiple original images according to the blending parameters.

Here, based on the intermediate feature data corresponding to each source viewpoint, the blending parameters corresponding to the predicted color information and the multiple pieces of candidate color information can be determined. For example, the blending parameters include a first parameter representing whether the spatial point is visible from the source viewpoint, or a second parameter representing a color weight, such that the blending parameters can be used to more accurately blend the predicted color information and the multiple pieces of candidate color information to obtain the target color information.

In a possible embodiment, the blending parameters include the first parameter, and determining the blending parameters corresponding to the predicted color information and the candidate color information corresponding to each of the multiple original images includes: based on a preset value, determining the first parameter corresponding to the predicted color information; for each of the multiple source viewpoints, determining depth information of the spatial point under the source viewpoint based on the position information of the spatial point; and based on the intermediate feature data corresponding to the source viewpoint and the depth information of the spatial point from the source viewpoint, generating the first parameter of the candidate color information corresponding to the source viewpoint.

Here, by determining the depth information of the spatial point from each source viewpoint, and using the intermediate feature data corresponding to each source viewpoint and the depth information of the spatial point from each source viewpoint, the first parameter corresponding to each candidate color information is generated more accurately, such that the first parameter can be subsequently used to generate the target color information more accurately.

In a possible embodiment, the blending parameters include the second parameter, and determining the blending parameters corresponding to the predicted color information and the candidate color information corresponding to each of the multiple original images includes: obtaining fused feature data, by performing a fusing process on the intermediate feature data corresponding to each of the multiple source viewpoints; generating key information based on first target feature data and second target feature data; where the first target feature data includes the fused feature data, the direction vector of the target viewpoint and the position information of the spatial point; the second target feature data includes the intermediate feature data corresponding to each of the multiple source viewpoints, direction vectors of the multiple source viewpoints and the position information of the spatial points; and the key information represents feature information of the predicted color information and the candidate color information corresponding to each of the multiple original images; generating query information based on the first target feature data, where the query information represents feature information of the predicted color information; and based on the key information and the query information, determining the second parameters corresponding to the candidate color information corresponding to each of the multiple original images and the predicted color information.

Here, second parameters corresponding to the multiple pieces of candidate color information and the predicted color information is generated, such that the second parameters can be subsequently used to more accurately blend the multiple pieces of candidate color information and the predicted color information to generate the target color information.

In a possible embodiment, obtaining the parameterized model corresponding to the to-be-rendered object includes: for each of the multiple original images, obtaining target key point information corresponding to the to-be-rendered object in the original image, by performing key point extraction on the original image; and obtaining information on projection points of multiple preset key points of a skinned model on the original image, by projecting the skinned model including the multiple preset key points onto a projection plane corresponding to the original image based on camera parameter information corresponding to the original image; obtaining adjusted model parameters, by adjusting model parameters of the skinned model based on the information on the projection points corresponding to the multiple preset key points and the target key point information corresponding to each of the multiple original images; and based on the adjusted model parameters, generating the parameterized model corresponding to the to-be-rendered object.

In the above embodiments, by using multiple original images corresponding to the to-be-rendered object, the parameterized model corresponding to the to-be-rendered object can be generated more easily and efficiently, such that the parameterized model corresponding to the to-be-rendered object can be subsequently used to generate the rendered image corresponding to the to-be-rendered object from any target viewpoint more efficiently.

In a possible embodiment, based on the volume densities and the target color information respectively corresponding to the multiple spatial points, generating the rendered image of the to-be-rendered object under the target viewpoint includes: based on camera parameter information corresponding to the target viewpoint, determining multiple reference spatial points in a three-dimensional space projected onto a target pixel point; based on the target color information and the volume densities corresponding to the multiple reference spatial points, determining pixel color of the target pixel point; and based on pixel colors of multiple target pixel points, generating the rendered image.

In a possible embodiment, the rendered image is generated by a trained target neural network, the target neural network is trained based on a constructed target dataset, the target dataset includes video data from different viewpoints corresponding to multiple sample users and a respective sample parameterized model corresponding to each of the multiple sample users; and the target dataset is constructed by: respectively capturing video data of each of the multiple sample users by multiple image capture devices, where different sample users correspond to different user attribute information, the user attribute information includes at least one of: body type, clothing, accessory, hairstyle or motion; based on the video data corresponding to each of the multiple sample users, generating the respective sample parameterized model corresponding to each of the multiple sample users; and based on the video data and the respective sample parameterized model corresponding to each of the multiple sample users, constructing the target dataset.

In the above embodiments, a target dataset with richer samples can be constructed. The target dataset can be used to train the target neural network more accurately, which improves the performance of the trained target neural network.

In a possible embodiment, after generating the rendered image, the method further includes: obtaining multiple rendered images corresponding to the to-be-rendered object from multiple target viewpoints; and based on the multiple rendered images, generating a rendered video corresponding to the to-be-rendered object.

Here, for each to-be-rendered user, a rendered image from any target viewpoint corresponding to the to-be-rendered user can be generated, which is more efficient in generating rendered images, and then based on the multiple rendered images, it is easier to generate a rendered video corresponding to the to-be-rendered object, which improves the efficiency of generating free-view videos. The process does not depend on the external environment, and the free-view video is generated in an easier way.

In a possible embodiment, after generating the rendered image, the method further includes: obtaining multiple rendered images corresponding to the to-be-rendered object under multiple target viewpoints; based on the multiple rendered images, generating a virtual model corresponding to the to-be-rendered object; and displaying the virtual model corresponding to the to-be-rendered object, by controlling a target device.

Here, for each to-be-rendered user, a rendered image can be generated for the to-be-rendered user corresponding to any target viewpoint, and the generation of the rendered image is more efficient. Then based on multiple rendered images, a virtual model corresponding to the to-be-rendered object can be generated more accurately and efficiently.

For the description of the effect of the following electronic devices, reference may be made to the description of the above-mentioned methods, which is not repeated here.

In a second aspect, in the present disclosure, an electronic device is provided, and includes: a processor, a memory and a bus, where the memory stores machine-readable instructions executable by the processor, the processor communicates with the memory via the bus when the electronic device is in operation, and when the machine-readable instructions are executed by the processor, the processor is caused to perform actions including: obtaining a parameterized model corresponding to a to-be-rendered object, where the parameterized model is constructed from pre-obtained multiple original images, and the multiple original images are images of the to-be-rendered object respectively captured at different multiple source viewpoints; based on a target viewpoint, determining multiple spatial points in a three-dimensional space corresponding to the parameterized model; for each of the multiple spatial points, for each of the multiple source viewpoints, based on position information of the spatial point, the parameterized model and the multiple original images, generating a target feature vector corresponding to the spatial point and matching the source viewpoint, where the target feature vector includes a visual feature of the spatial point at the corresponding source viewpoint; and based on multiple target feature vectors corresponding to the spatial point and candidate color information of a projection point of the spatial point on each of the multiple original images, generating volume density and target color information corresponding to the spatial point; and based on volume densities and target color information respectively corresponding to the multiple spatial points, generating a rendered image of the to-be-rendered object under the target viewpoint.

In a third aspect, in the present disclosure, a non-transitory computer-readable storage medium is provided, where the computer-readable storage medium stores a computer program, and when the computer program is executed by a processor, the processor is caused to perform actions including: obtaining a parameterized model corresponding to a to-be-rendered object, where the parameterized model is constructed from pre-obtained multiple original images, and the multiple original images are images of the to-be-rendered object respectively captured at different multiple source viewpoints; based on a target viewpoint, determining multiple spatial points in a three-dimensional space corresponding to the parameterized model; for each of the multiple spatial points, for each of the multiple source viewpoints, based on position information of the spatial point, the parameterized model and the multiple original images, generating a target feature vector corresponding to the spatial point and matching the source viewpoint, where the target feature vector includes a visual feature of the spatial point at the corresponding source viewpoint; and based on multiple target feature vectors corresponding to the spatial point and candidate color information of a projection point of the spatial point on each of the multiple original images, generating volume density and target color information corresponding to the spatial point; and based on volume densities and target color information respectively corresponding to the multiple spatial points, generating a rendered image of the to-be-rendered object under the target viewpoint.

In order to make the above-mentioned objects, features and advantages of the present disclosure more comprehensible, preferred embodiments are described in detail below together with the accompanying drawings.

### BRIEF DESCRIPTION OF DRAWINGS

In order to more clearly illustrate the technical solutions of the embodiments of the present disclosure, the following briefly introduces the accompanying drawings that need to be used in the embodiments. Accompanying drawings herein are incorporated into and constitute a part of the specification, illustrate embodiments consistent with the present disclosure, and are combined with the description to explain the technical solutions of the present disclosure. It should be understood that the following drawings illustrate only certain embodiments of the present disclosure and therefore should not be regarded as limiting the scope. For those skilled in the art, other related drawings can also be obtained based on these drawings without creative effort.

FIG. 1 is a schematic flowchart of an object rendering method according to embodiments of the present disclosure.

FIG. 2 is a schematic diagram of multiple source viewpoints in an object rendering method according to embodiments of the present disclosure.

FIG. 3a is a schematic diagram of a to-be-rendered object in an original image from a source viewpoint, in an object rendering method according to embodiments of the present disclosure.

FIG. 3b is a schematic diagram of a depth map of a parameterized model corresponding to a to-be-rendered object from a source viewpoint, in an object rendering method according to embodiments of the present disclosure.

FIG. 4 is a schematic structural diagram of a target neural network in an object rendering method according to embodiments of the present disclosure.

FIG. 5 is a schematic flowchart of an object rendering method according to embodiments of the present disclosure.

FIG. 6 is a schematic structural diagram of an object rendering apparatus according to embodiments of the present disclosure.

FIG. 7 is a schematic structural diagram of an electronic device according to embodiments of the present disclosure.

### DETAILED DESCRIPTION

In order to make the purpose, technical solutions and advantages of the embodiments of the present disclosure clearer, the technical solutions in the embodiments of the present disclosure are clearly described below with reference to the accompanying drawings in the embodiments of the present disclosure. The embodiments described are merely some embodiments of the present disclosure, and not all embodiments. Generally, the components in the embodiments of the present disclosure described and illustrated in the accompanying drawings herein can be arranged and designed in a variety of different configurations. Accordingly, the following detailed description of embodiments of the present disclosure provided in the accompanying drawings is not intended to limit the claimed scope of the present disclosure, but merely represents selected embodiments of the present disclosure. Other embodiments achieved by those skilled in the art based on the embodiments in the present disclosure without paying creative work shall all fall within the scope of protection of the present disclosure.

Since the generation environment of free-view-video is more complex, such as the generation environment requires a professional photography environment, more shooting viewpoints, etc., which makes the generation of free-view video more difficult. If a free-view video of a human body can be generated from images with fewer viewpoints, it can greatly enhance the convenience of each scenario using free-view video in daily life, for example, it can enhance the convenience of accessing three-dimensional immersive interaction in daily life.

In general, when generalizing and rendering an image of a human body in a new viewpoint using images with fewer viewpoints and enhancing the robustness and generalization, there are two main dimensions of difficulties to be solved: 1) generalizing any unknown human body and unknown human-body poses, movements, clothing, and external accessories; and 2) stable high-quality rendering when changing viewpoints. However, there is no better way to solve the above mentioned difficulties.

Therefore, in a method, the human body is modelled in three-dimensional using a depth camera or other geometric scanner to obtain a three-dimensional model of the human body. The three-dimensional model of the human body can then be used to obtain the corresponding free-view video of the human body, which lacks the generalization ability to unknown human bodies, and the process of generating the free-view video in the above method is cumbersome and inefficient. In another method, the deep learning network is used to get the free-view video corresponding to a human body by learning the three-dimensional geometric features and texture features of the human body. Since the human body has variables such as body pose, movement, and clothing, it is difficult to render a clear free-view video by this method.

To alleviate the above problems, in embodiments of the present disclosure, object rendering methods and apparatuses, and electronic devices and storage media are provided. In the above method, the original images from multiple source viewpoints of the to-be-rendered object are used to generate a rendered image from any target viewpoint. The rendering process does not need to rely on a professional photography environment, and the rendering process is more stable and more efficient. Furthermore, a free-view video can be obtained according to the rendered image from any target viewpoint.

In the present disclosure, a parameterized model corresponding to the to-be-rendered object is used. The parameterized model is a model representing the geometry of the pose of the to-be-rendered object, and using this parameterized model can generalize any unknown human body and unknown human body pose; and the parameterized model is generated by determining the model parameters through multiple original images. Compared with the way to get a three-dimensional model of human body by using a depth camera or other geometric scanner to model the human body in three-dimensional, the process of establishing the parameterized model in the present disclosure focuses on the pose of the to-be-rendered object, without the need to pay attention to other information unrelated to the pose such as clothing information, hair information, etc. The method of determining the parameterized model is more efficient and simple.

In the present disclosure, the parameterized model and the position information of the spatial point are used to determine the target feature vector corresponding to the spatial point matching each of the source viewpoints, such that the implicit geometric features of the spatial point relative to the parameterized model can be embedded into the target feature vector, and the target feature vector can present the features of the pose of the to-be-rendered object. The position information of the spatial point and the original images are used, such that the visual features in the original images can be embedded into the target feature vector. The visual features include, for example, the clothing features and external decoration features of the to-be-rendered object, such that the target feature vector can represent the clothing and external decoration features of the to-be-rendered object. The multiple target feature vectors corresponding to the spatial point and candidate color information of a projection point of the spatial point on each of the multiple original images are used to determine volume density and target color information corresponding to the spatial point more accurately. The volume densities and color information respectively corresponding to multiple spatial points are used to generate a rendered image of the to-be-rendered object from the target viewpoint more accurately. i.e., the rendered image in any target viewpoint can be generated more accurately.

It should be noted that similar reference signs and letters in the following drawings indicate similar items, therefore, once an item is defined in one drawing, it does not need to be further defined and explained in subsequent drawings.

To facilitate understanding of embodiments of the present disclosure, an object rendering method disclosed in embodiments of the present disclosure is first described in detail. The execution subject of the object rendering method provided in the embodiments of the present disclosure is generally a computer device with a certain computing ability. The computer device includes, for example, a terminal device, a server or other processing device. The terminal device may include a User Equipment (UE), a mobile device, a user terminal, a terminal, a Personal Digital Assistant (PDA), a handheld device, a computing device, a wearable device, etc. In some possible embodiments, the object rendering method may be implemented by a processor invoking computer-readable instructions stored in a memory.

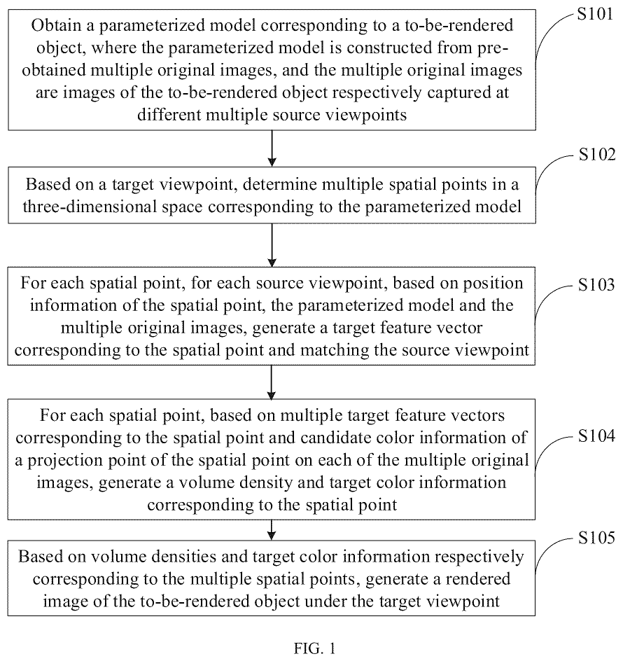

Referring to FIG. 1, a schematic flowchart of an object rendering method according to embodiments of the present disclosure, the method includes S101-S104

In S101, a parameterized model corresponding to a to-be-rendered object is obtained, where the parameterized model is constructed from pre-obtained multiple original images, and the multiple original images are images of the to-be-rendered object respectively captured at different multiple source viewpoints.

In S102, based on a target viewpoint, multiple spatial points in a three-dimensional space corresponding to the parameterized model are determined.

For each spatial point determined at step S102, steps S103 and S104 are performed.

In S103, for each source viewpoint, based on position information of the spatial point, the parameterized model and the multiple original images, a target feature vector corresponding to the spatial point and matching the source viewpoint is generated. The target feature vector includes a visual feature of the spatial point from a corresponding source viewpoint.

In S104, based on multiple target feature vectors corresponding to the spatial point and candidate color information of a projection point of the spatial point on each of the multiple original images, a volume density and target color information corresponding to the spatial point are generated.

After the above steps S103 and S104 are performed for each of the multiple spatial points, the volume densities and pieces of the target color information respectively corresponding to the multiple spatial points are obtained, and then step S105 is performed.

In S105, based on volume densities and target color information respectively corresponding to the multiple spatial points, a rendered image of the to-be-rendered object under the target viewpoint is generated.

Steps S101-S105 are described in detail below.

### For S101:

multiple original images corresponding to the to-be-rendered object are obtained. Each original image corresponds to one source viewpoint, and different original images correspond to different source viewpoints. The to-be-rendered object can be a human body with any pose, any dress, any body shape, any accessory, etc., or, the to-be-rendered object can be an animal with any pose, etc. The source viewpoint may be determined based on the difference between the capture direction of the image capture device and the preset direction of the to-be-rendered object when the original image is being captured, that is, the source viewpoint matches the capture direction relative to the to-be-rendered object. For example, if the preset direction of the to-be-rendered object is the front direction, and if the image capture device captures the original image from the back side, the angle for the source viewpoint corresponding to the original image is 180°.

In some embodiments, multiple image capture devices can be controlled to acquire the original images of the to-be-rendered object from different source viewpoints. Alternatively, one image capture device can be controlled to sequentially acquire the original images of the to-be-rendered object from different source viewpoints. For example, starting from the front of the to-be-rendered object, source viewpoints can be determined in a clockwise direction. For example, the angle of the source viewpoint corresponding to original image 1 may be 0°, original image 1 may be an image captured by the image capture device from the front of the to-be-rendered object; the angle of the source viewpoint corresponding to original image 2 may be 180°, for example, original image 2 may be an image captured by the image capture device from the back of the to-be-rendered object.

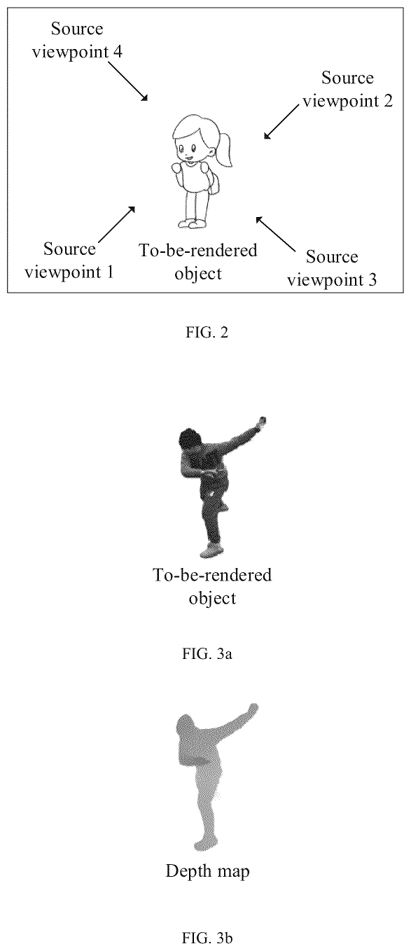

The number of and angles for the different source viewpoints can be selected as desired. Referring to FIG. 2, the to-be-rendered object has four source viewpoints, such as source viewpoint 1 for the front side of the to-be-rendered object, source viewpoint 2 for the back side of the to-be-rendered object, source viewpoint 3 for the left side of the to-be-rendered object, and source viewpoint 4 for the right side of the to-be-rendered object. The image capture device can capture an original image of the to-be-rendered object from a corresponding source viewpoint.

After capturing multiple original images corresponding to the to-be-rendered object, a parameterized model corresponding to the to-be-rendered object can be generated using the multiple original images. The parameterized model is generated by determining model parameters from the multiple original images, and the parameterized model is a least dressed model including geometric features such as pose and motion of the to-be-rendered object, i.e., the parameterized model does not include features of the to-be-rendered object that are not related to the motion and pose, and other features may include, for example, hair features, clothing features, accessory features, etc. When the to-be-rendered object is a human body, the parameterized model can be a Skinned Multi-Person Linear (SMPL) model or an SMPL-x model. The parameterized model can be controlled by body parameters and motion parameters, and the parameterized model of the to-be-rendered object can be obtained by determining the body parameters and motion parameters of the to-be-rendered object.

In some embodiments, the model parameter information (including, for example, body parameters and motion parameters) can be determined based on contour information of the to-be-rendered object in the multiple original images, and the parameterized model corresponding to the to-be-rendered object can be generated based on the model parameter information. Alternatively, the model parameter information of the canonical model can be adjusted based on the contour information of the to-be-rendered object in the multiple original images, and then the parameterized model corresponding to the to-be-rendered object can be generated based on the adjusted model parameters. The canonical model can be a pre-constructed parameterized model with a standard body and a standard motion (e.g., a motion of opening both arms).

In a possible embodiment, based on the multiple original images, generating the parameterized model corresponding to the to-be-rendered object includes steps A1 to A3.

In step A1, for each of the multiple original images, key point extraction is performed on the original image to obtain target key point information corresponding to the to-be-rendered object in the original image. Based on the camera parameter information corresponding to the original image, the skinned model including multiple preset key points is projected onto a projection plane corresponding to the original image to obtain the projection points of the multiple preset key points on the original image information on the original image.

In step A1, a trained first neural network for key point extraction can be used to extract key points from the original image to obtain the target key point information of the to-be-rendered object in the original image. For example, a type of a target key point may include at least one of a skeleton key point, a gesture key point, a face key point, etc., and the target key point information may include the position information, identification information, etc. of each target key point. Then the target key point information corresponding to each original image can be obtained.

The camera parameter information corresponding to the original image includes the internal and external parameters of the camera when the original image is captured.

The skinned model is a pre-built parameterized model, and the skinned model includes multiple preset key points, where the type and number of the preset key points can be set as required. And the skinned model has the model parameter information correspondingly.

Using the camera parameter information corresponding to the original image, the skinned model is projected onto the projection plane corresponding to the original image, and the projection image of the skinned model on the projection plane and first pixel positions of the multiple preset key points on the projection image are obtained, and then information (such as position information) of the projection point of each preset key point on the original image can be determined based on the first pixel positions.

The type of the target key point is matched with the type of the preset key point. For example, the type of the target key point may be the same as the type of the preset key point; or, the types of the target key points include the types of the preset key points.

In step A2, based on the information on the projection points corresponding to the multiple predetermined key points and the target key point information corresponding to each the original image, model parameters of the skinned model is adjusted to obtain adjusted model parameters.

In step A2, for each preset key point, the target key point matching the preset key point is determined from the target key points of the multiple original images. For example, the matching relationship between the preset key point and the target key point can be determined based on the identification information. Then, based on the information of the projection point of the preset key point on each original image, and the position information of the matched target key point in the original image, the position difference value of the preset key point relative to the original image is determined; and then the position difference values of the preset key point relative to the multiple original images can be obtained. Further, the model parameters, such as the body parameters and/or the motion parameters, of the skinned model can be adjusted based on the multiple position difference values corresponding to the preset key point to obtain the adjusted model parameters.

In step A3, based on the adjusted model parameters, the parameterized model corresponding to the to-be-rendered object is generated.

In the above embodiments, by using multiple original images corresponding to the to-be-rendered object, the parameterized model corresponding to the to-be-rendered object can be generated more easily and efficiently, such that the parameterized model corresponding to the to-be-rendered object can be subsequently used to generate the rendered image corresponding to the to-be-rendered object from any target viewpoint more efficiently.

### For S102:

In some embodiments, a three-dimensional space with the center point of the parameterized model as the origin can be constructed in advance. This three-dimensional space corresponds to a preset three-dimensional coordinate system. Considering that the sizes of the parameterized models may not be uniform, which makes the sizes of the constructed three-dimensional spaces inconsistent, after the parameterized model is obtained, the size of the parameterized model can be adjusted to obtain the parameterized model under the standard size. Then the center point of the adjusted parameterized model is used as the origin to construct the three-dimensional space.

In some embodiment, the target viewpoint is set, and the target viewpoint can be set according to the actual needs. For example, when the right-side image of the to-be-rendered object is desired to be rendered, the target viewpoint from which the right side image can be generated can be determined, and the target viewpoint can be, for example, 90°. Based on the set target viewpoint, a number of spatial points can be determined from the three-dimensional space corresponding to the parameterized model, and the position information of each spatial point in the preset three-dimensional coordinate system can be obtained.

For example, based on the target viewpoint and the camera parameter information corresponding to the target viewpoint, multiple rays with the camera position indicated by the camera parameter information as the origin can be determined. The multiple spatial points are then obtained by sampling from local line segments located in the three-dimensional space.

### For S103:

In some embodiments, for each spatial point, the volume density a and the target color information of the spatial point can be determined, such that the rendered image from the target viewpoint can be subsequently rendered using the volume density and the target color information of each spatial point. The volume density is used to represent the probability of light being terminated when passing through the spatial point during the image rendering process, volume density is the volume density used in the volume rendering method. Each spatial point represents a volume, and the volume density of the spatial point is proportional to the probability of a light being terminated when it passes through the spatial point, i.e., the greater the volume density of the spatial point, the higher the probability of a light being terminated when it passes through the spatial point, which indicates the lower the transparency of the spatial point. For example, the volume density of a spatial point located on the surface of the human body in the three-dimensional space is greater than the volume density of other spatial points located in front of the surface of the human body.

For example, the position information of the spatial points, the parameterized model and the multiple original images can be input to the target neural network, and a target feature vector corresponding to each source viewpoint can be obtained using the first network in the target neural network. The first network is configured to fuse the determined visual features of the spatial point with the implicit geometric features of the spatial point, for example, the first network may include an encoder module. The encoder module is used to extract the visual features of the original images, and then based on the position information of the spatial point and the extracted visual features of the original images, the visual features of the spatial point from each source viewpoint are determined. The first network may further include a geometric feature determining module. The geometric feature determining module is configured to determine implicit geometric features between the spatial point and the parameterized model. The first network further includes a cascade layer, the cascade layer is configured to cascade the visual features corresponding to the spatial point with the implicit geometric features corresponding to the spatial point to obtain the target feature vector.

In an optional embodiment, based on position information of the spatial point, the parameterized model and the multiple original images, generating a target feature vector corresponding to the spatial point and matching the source viewpoint includes steps B1 to B3.

In step B1, based on the position information of the spatial point and the parameterized model, a first feature vector corresponding to the spatial point is generated. The first feature vector is configured to represent an implicit geometric feature between the spatial point and the parameterized model.

In step B2, for each source viewpoint, based on the position information of the spatial point and the original image corresponding to the source viewpoint, a second feature vector corresponding to the source viewpoint is generated. The second feature vector is configured to represent the visual features of the spatial point on the original image corresponding to the source viewpoint.

In step B3, based on at least one of the first feature vector, the second feature vector corresponding to the source viewpoint, the position information of the spatial point or a direction vector corresponding to the target viewpoint, a target feature vector corresponding to the spatial point and matching the source viewpoint is generated.

In step B1, the position information of the spatial point and the parameterized model can be used to generate a first feature vector corresponding to the spatial point. The first feature vector is configured to represent an implicit geometric feature between the spatial point and the parameterized model. The implicit geometry is used to represent a relationship between a point and another point, rather than a specific location of a point, here the implicit geometric feature can represent the relationship between the spatial point and a model point on the parameterized model. For example, based on the position information of the spatial point and the parameterized model, the signed distance function (SDF) corresponding to the spatial point can be determined, and the value of the SDF can be used to represent the proximity between the spatial point and the parameterized model. Then the first feature vector can be generated based on the value of the SDF.

Based on the position information of the spatial point and the parameterized model, generating a first feature vector corresponding to the spatial point includes steps B11 to B14.

In step B11, based on the position information of the spatial point, a target model point on the parameterized model with the smallest distance from the spatial point is determined.

In step B12, based on the position information of the spatial point and position information of the target model point, distance information and direction information of the spatial point relative to the parameterized model is determined.

In step B13, based on a mapping relationship between a first model point on the parameterized model and a second model point on a canonical model, position information of a second model point corresponding to the target model point is determined.

In step B14, based on at least one of the distance information, the direction information or the position information of the second model point corresponding to the target model point, the first feature vector corresponding to the spatial point is generated.

In step B11, if the spatial point is not located on the parameterized model, based on the position information of the spatial point, a target model point on the parameterized model with the smallest distance from the spatial point can be determined. The distance can be a Euclidean distance, a Marxian distance, etc. If the spatial point is located on the parameterized model, the spatial point is the target model point.

In step B12, the position information of the spatial point and position information of the target model point can be used to determine distance information of the spatial point relative to the parameterized model. For example, a minimum distance between the spatial point and the parameterized model can be determined, and the minimum distance is determined as the distance information. Alternatively, the SDF value of the spatial point relative to the parameterized model can be determined, and the SDF value is determined as the distance information.

The position information of the spatial point and the position information of the target model point are used to determine the direction vector corresponding to the minimum distance between the spatial point and the parameterized model, and the direction vector is determined as the direction information. Alternatively, a partial derivative function of the SDF of the spatial point relative to the parameterized model can be determined to obtain the direction information. The direction information can represent the direction of the spatial point approaching the parameterized model.

In step B13, the canonical model can be a standard human body model under a standard physique and a standard movement. The canonical model can be a three-dimensional mesh model consisting of multiple irregular triangular surface pieces. For example, when the to-be-rendered object is a human body, the form with preset height, preset weight, and preset body proportion can be determined as the standard form; and the motion of opening arms can be determined as the standard motion.

The second model point on the canonical model has a mapping relationship with the first model point on the parameterized model, and after the target model point is determined, the position information of the second model point corresponding to the target model point can be determined according to the mapping relationship, such that the position information of the second model point can be used to provide semantic information for the spatial point. For example, if the position information of the second model point indicates that the second model point is the model point on the head, then the position information of the second model point provides the semantic information of the head for the spatial point.

In step B14, based on at least one of the distance information, the direction information or the position information of the second model point corresponding to the target model point, the first feature vector corresponding to the spatial point is generated. For example, a first combined vector of g=(a, b1, b2, b3, x1, y1, z1) can be used as the first feature vector, where a is the distance information, b1, b2 and b3 are the direction information, and x1, y1 and z1 are the position information of the second model point. Alternatively, feature extraction can be performed on the first combined vector (a, b1, b2, b3, x1, y1, z1) to obtain the first feature vector corresponding to the spatial point.

Here, by determining the first feature vector corresponding to the spatial point, which is configured to represent the implicit geometric features between the spatial point and the parameterized model, an implicit geometric estimation of the parameterized model is realized, such that when the target feature vector is generated using the first feature vector, the target feature vector has the geometric features of the parameterized model, and thus the target feature vector can be subsequently used to more accurately determine volume density and target color information of the spatial point, improving the accuracy of the rendered image.

In step B2, the second feature vector corresponding to each source viewpoint can be determined. In some embodiments, for each source viewpoint, based on the position information of the spatial point and the original image corresponding to the source viewpoint, a second feature vector corresponding to the source viewpoint is generated. The second feature vector is configured to represent the visual features of the spatial point on the original image corresponding to the source viewpoint.

For example, the position information of the spatial point can be used to determine the pixel information of the projection point of the spatial point on the original image corresponding to the source viewpoint, and the pixel information of the projection point can be used to generate the second feature vector corresponding to the source viewpoint. Alternatively, the pixel information of the projection points and other pixel points located around the projection points can be used to generate the second feature vector corresponding to the source viewpoint. For example, the pixel information can be used as the second feature vector, or, the pixel information can be linearly interpolated to obtain the second feature vector corresponding to the source viewpoint.

Based on the position information of the spatial point and the original image corresponding to the source viewpoint, generating a second feature vector corresponding to the source viewpoint may include steps B21 to B23.

In step B21, a visual feature map for the original image corresponding to the source viewpoint is generated, by performing feature extraction on the original image.

In step B22, based on the position information of the spatial point and camera parameter information corresponding to the original image, feature information of a target feature point on the visual feature map corresponding to the spatial point is determined.

In step B23, based on the feature information of the target feature point, the second feature vector corresponding to the source viewpoint is generated.

In some embodiments, for each source viewpoint, the encoder can be used to extract features from the original image under the source viewpoint to obtain the visual feature map corresponding to the original image. The visual feature map can be multi-channel feature data.

Then, based on the camera parameter information corresponding to the original image and the position information of the spatial point, the target feature point matching the spatial point on the visual feature map is determined, and the feature information of the target feature point is obtained. For example, the feature information of the target feature point can be a feature vector, and the dimension of this feature vector is consistent with the number of the channels.

The feature information of the target feature point can then be determined as a second feature vector corresponding to the source viewpoint. Alternatively, at least one processing such as feature extraction processing, fusion processing, or interpolation processing can be performed on the feature information of the target feature point to obtain the second feature vector corresponding to the source viewpoint.

Here, by determining the second feature vector corresponding to each source viewpoint, which is used to represent the image features of the spatial point on the original image corresponding to the source viewpoint, such that when a target feature vector is generated by using the second feature vector, the target feature vector has the attribute features of the to-be-rendered object, such as clothing and hairstyle, and thus the volume density and the target color information of the spatial point can be more accurately determined by using the target feature vector, which improves the accuracy of the rendered image.

In step B3, based on at least one of the first feature vector, the second feature vector corresponding to the source viewpoint, the position information of the spatial point or a direction vector corresponding to the target viewpoint, a target feature vector corresponding to the spatial point and matching the source viewpoint can be generated.

For example, the second combined vector (x, d, g, fi) can be determined as the target feature vector corresponding to the i-th source viewpoint, where x is the position information of the spatial point, d is the direction vector corresponding to the target view, g is the first feature vector, and fi is the second feature vector corresponding to the i-th source viewpoint, where i is a positive integer. Alternatively, feature extraction, fusion processing, etc. can be performed on the second combined vector to generate the target feature vector.

### For S104:

After obtaining the multiple target feature vectors, the volume density and predicted color information corresponding to the spatial point can be generated based on the multiple target feature vectors corresponding to the spatial point. The predicted color information is a predicted color information of the spatial point from the target viewpoint. Based on the multiple target feature vectors corresponding to the spatial point, blending parameters corresponding to the predicted color information and the candidate color information are generated. Finally, based on the candidate color information of the projection point of the spatial point on each original image, the predicted color information and the blending parameters, the target color information corresponding to the spatial point is obtained by blending.

For example, the multiple target feature vectors corresponding to the spatial point and the candidate color information of the projection point of the spatial point projected on each original image can be input to the target neural network, and a second network of the target neural network can be used to generate the volume density and target color information corresponding to the spatial point. For example, the second network can include multiple convolutional layers, and the set multiple convolutional layers are used to perform feature extraction on multiple target feature vectors, and the extracted features are used to determine the volume density and predicted color information of the spatial point, and then the predicted color information is fused with the candidate color information corresponding to each of the multiple original images, for example, the predicted color information and multiple pieces of the candidate color information are added or weighted sum, to obtain the target color information of the spatial point.

After the volume density and target color information of each spatial point are obtained, the pixel color of each target pixel point can be obtained by integrating the volume densities and target color information of the multiple spatial points.

In some embodiments, based on multiple target feature vectors corresponding to the spatial point and candidate color information of a projection point of the spatial point on each of the multiple original images, generating a volume density and target color information corresponding to the spatial point includes steps C1 to C3.

In step C1, intermediate feature data corresponding to each of the multiple source viewpoints is generated, by performing feature extraction on each of the multiple target feature vectors.

In step C2, based on the intermediate feature data corresponding to the multiple source viewpoints, the volume density and predicted color information corresponding to the spatial point are generated.

In step C3, based on the predicted color information and the candidate color information of the projection point of the spatial point on each of the multiple original images, the target color information corresponding to the spatial point is generated.

Considering that when the number of source viewpoints is small, there is a situation where the spatial point is occluded from each source viewpoint. In this situation, if the candidate color information corresponding to the spatial point is blended, it causes a large error in the obtained target color information, and the robustness is poor. In order to alleviate the above problem, intermediate feature data corresponding to each source viewpoint can be used to generate the predicted color information corresponding to the spatial point. Such that the blending parameters, the predicted color information and multiple pieces of candidate color information can be subsequently used to generate the target color information corresponding to the spatial point more accurately.

In step C1, intermediate feature data corresponding to each of the multiple source viewpoints is generated, by using multiple convolutional layers to perform feature extraction on each of the multiple target feature vectors. For example, feature extraction is performed on the target feature vector corresponding to source viewpoint 1 to obtain intermediate feature data corresponding to source viewpoint 1. The intermediate feature data can be multi-channel feature data.

In step C2, the intermediate feature data corresponding to each source viewpoint can be fused to obtain fused feature data. Multiple convolutional layers are then used for feature extraction on the fused feature data to generate volume density and predicted color information corresponding to the spatial point.

For example, five convolutional layers can be set. First, the convolutional layer 1 is used to perform feature extraction on the fused feature data to obtain the first feature data; second, the first feature data, the position information of the spatial point and the first feature vector are input to the convolutional layer 2 for feature extraction to obtain the second feature data; third, the convolutional layer 3 is used to perform feature extraction on the second feature data to obtain the third feature data; fourth, the third feature data, the position information of the spatial point, the direction vector for the target viewpoint and the first feature vector are input to the convolutional layer 4 for feature extraction to obtain the fourth feature data; and fifth, the fourth feature data and the direction vector of the target viewpoint are input to the convolutional layer 5 for feature extraction to obtain the volume density and predicted color information corresponding to the spatial point.

In step C3, the predicted color information, and the candidate color information of the projection point of the spatial point on each of the original images can be fused to obtain the target color information. Alternatively, the predicted color information and pieces of the candidate color information can be weighted and fused to obtain the target color information. Alternatively, the predicted color information can also be determined as the target color information corresponding to the spatial point.

In some possible embodiments, based on the predicted color information and the candidate color information of the projection point of the spatial point on each of the multiple original images, generating the target color information corresponding to the spatial point includes:

determining the blending parameters respectively corresponding to the predicted color information and multiple pieces of the candidate color information, where the blending parameters include first parameters representing the visibility of the spatial point from the corresponding source viewpoint, and/or, a second parameter representing the color information weight; and according to the blending parameters, blending the predicted color information and the multiple pieces of the candidate color information, to generate the target color information corresponding to the spatial point.

Here, based on the intermediate feature data corresponding to each source viewpoint, the blending parameters corresponding to the predicted color information and the multiple pieces of candidate color information can be determined. For example, the blending parameters include a first parameter representing whether the spatial point is visible from the source viewpoint, or a second parameter representing a color weight, such that the blending parameters can be used to more accurately blend the predicted color information and the multiple pieces of candidate color information to obtain the target color information.

In embodiments, the blending parameters can be determined based on the intermediate feature data corresponding to each source viewpoint. The blending parameters include first parameters and second parameters. For example, a convolutional layer can be used to extract features from the intermediate feature data corresponding to each viewpoint to obtain the first parameters respectively corresponding to the predicted color information and the multiple pieces of the candidate color information. Alternatively, an attention mechanism network may also be used to extract features from the intermediate feature data corresponding to each viewpoint to obtain the second parameters respectively corresponding to the predicted color information and the multiple pieces of the candidate color information.

In a manner, the first parameters respectively corresponding to the predicted color information and the multiple pieces of the candidate color information, is determined by the following steps: determining the first parameter corresponding to the predicted color information based on a preset value; and for each source viewpoint, determining the depth information of the spatial point under the source viewpoint based on the position information of the spatial point; based on the intermediate feature data corresponding to the source viewpoint and the depth information of the spatial point under the source viewpoint, generating the first parameter of the candidate color information corresponding to the source viewpoint.

In embodiments, the preset value can be determined as the value of the first parameter corresponding to the predicted color information, for example, the preset value can be 1, i.e., representing the visibility of the predicted color information as visible.

The first parameter corresponding to the candidate color information is determined according to the following steps D1 to D2.

In step DL, based on the position information of the spatial point, depth information of the spatial point from each source viewpoint is determined.

At each source viewpoint, if the spatial point is occluded by a model point of the parameterized model, the depth value of the spatial point is greater than the depth value of the model point at the source viewpoint. According to the depth information, the visibility of a spatial point from the source viewpoint can be determined.

In a manner, based on the position information of the spatial point and the camera parameter information corresponding to each source viewpoint, the depth value of the spatial point from the image capture device under the source viewpoint can be determined, and the depth value is determined as the depth information under the source viewpoint. Then the depth information of the spatial point under each source viewpoint can be obtained.

In a manner, first, based on the parameterized model, a depth map corresponding to the parameterized model for each source viewpoint can be generated. For example, the parameterized model can be rasterized. For each source viewpoint, the depth value of each visible raster at the source viewpoint are determined; based on the determined depth value of each raster, the depth map corresponding to the source viewpoint is generated. Then for each source viewpoint, based on the position information of the spatial point and the camera parameter information corresponding to the source viewpoint, the feature point matched with the spatial point in the depth map is determined, and the depth value of the feature point is determined as the depth information of the spatial point under the source viewpoint. Then the depth information of the spatial point under each source viewpoint can be obtained.

Referring to FIG. 3a, which shows the to-be-rendered object in the original image from the source viewpoint, the depth map of the parameterized model corresponding to the to-be-rendered object from the source viewpoint is shown in FIG. 3b.

In step D2, based on the intermediate feature data corresponding to each source viewpoint and the depth information of the spatial point under each source viewpoint, the first parameter corresponding to each candidate color information is generated.

In embodiments, at least one convolutional layer can be used to extract features from the intermediate feature data corresponding to each source viewpoint and the depth information of the spatial point under each source viewpoint to generate the first parameter corresponding to each candidate color information.

Alternatively, for each source viewpoint, the intermediate feature data corresponding to the source viewpoint, the depth information of the spatial point under the source viewpoint, and the candidate color information corresponding to the original image from the source viewpoint can be used to generate a third combined data corresponding to each source viewpoint. Then the third combined data corresponding to each source viewpoint can be obtained. At least one convolutional layer is used to extract features from the third combined data corresponding to each source viewpoint, and the first parameter corresponding to each candidate color information is generated.

The value of the first parameter can be 0 or 1. The first parameter being 0 represents that the spatial point is not visible, and the first parameter being 1 represents that the spatial point is visible.

Here, by determining the depth information of the spatial point from each source viewpoint, and using the intermediate feature data corresponding to each source viewpoint and the depth information of the spatial point from each source viewpoint, the first parameter corresponding to each candidate color information is generated more accurately, such that the first parameter can be subsequently used to generate the target color information more accurately.

In a manner, the second parameters respectively corresponding to the predicted color information and the multiple pieces of the candidate color information are determined according to the following steps E1 to E3.

In step E1, the intermediate feature data corresponding to each source viewpoint can be fused to obtain fused feature data.

In step E2, based on the first target feature data and the second target feature data, key information is generated; and based on the first target feature data, query information is generated.

The first target feature data includes the fused feature data, the direction vector of the target viewpoint and the position information of the spatial point; the second target feature data includes the intermediate feature data corresponding to each of the multiple source viewpoints, direction vectors of the multiple source viewpoints and the position information of the spatial points; the key information represents feature information of the predicted color information and the candidate color information corresponding to each of the multiple original images; and the query information represents feature information of the predicted color information.

In step E3, based on the key information and the query information, the second parameters respectively corresponding to the multiple pieces of the candidate color information and the predicted color information are determined.

In embodiments, at least one convolutional layer can be used to fuse the intermediate feature data corresponding to each source perspective to obtain fused feature data.

The fused feature data, the direction vector of the target viewpoint, and the position information of the spatial point are cascaded to obtain the first target feature data. For each source viewpoint, the intermediate feature data corresponding to that source viewpoint, the direction vector of the source viewpoint, and the position information of the spatial point are cascaded to obtain the local feature data corresponding to the source viewpoint. The local feature data corresponding to each source viewpoint constitutes the second target feature data.

At least one convolutional layer is used to perform feature extraction on the first target feature data to generate the query information Q corresponding to the predicted color information. And at least one convolutional layer is used to perform feature extraction on the first target feature data and the second target feature data to generate the key information KT corresponding to the predicted color information and the multiple pieces of the candidate color information. The query information Q and the key information KT are then subjected to a dot product operation to obtain the second parameters respectively corresponding to the multiple pieces of the candidate color information and the predicted color information.

Since the key information represents the feature information of the predicted color information and the multiple pieces of the candidate color information, and the query information represents the feature information of the predicted color information, by comparing the key information with the query information, the second parameters respectively corresponding to the feature of the predicted color information and the multiple pieces of the candidate color information is determined.

Here, second parameters corresponding to the multiple pieces of candidate color information and the predicted color information is generated, such that the second parameters can be subsequently used to more accurately blend the multiple pieces of candidate color information and the predicted color information to generate the target color information.

When the blending parameters include the first parameters, the predicted color information and the multiple pieces of the candidate color information can be respectively multiplied with the corresponding first parameters, and then the obtained first product values are added to obtain the target color information corresponding to the spatial point.

When the blending parameters include the second parameters, the predicted color information and the multiple pieces of the candidate color information can be respectively multiplied with the corresponding second parameters, and then the obtained second product values are added to obtain the target color information corresponding to the spatial point.

When the blending parameters include the first parameters and the second parameters, the first parameters and the second parameters can be correspondingly multiplied first to obtain target parameters. For example, the second parameter and the first parameter corresponding to the predicted color information can be multiplied to obtain the target parameter corresponding to the predicted color information. Then, the predicted color information and the multiple pieces of the candidate color information are respectively multiplied with the target parameters correspondingly, and the obtained third product values are added to obtain the target color information corresponding to the spatial point.

### For S105:

After obtaining the volume density and target color information corresponding to each spatial point, the volume density and target color information of the spatial point in the three-dimensional space projected onto the same target pixel point can be rendered according to the classical integral rendering formula to obtain the pixel color of the target pixel point. Then based on pixel colors of multiple target pixel points, the rendered image is generated. The classical integral rendering formula is:

$$C ( r ) = {\int }_{{t}_{n}}^{{t}_{f}} exp ( - {\int }_{{t}_{n}}^{t} σ ( r ( s ) ds ) ) σ cdt$$

where C(r) is the pixel color corresponding to the target pixel point, a is the volume density of the spatial point, c is the target color information of the spatial point, and t_{f} and tₙ are the farthest boundary and the nearest boundary on the three-dimensional space.

In some embodiments, based on the volume density and target color information corresponding to each spatial point, generating the rendered image of the target viewpoint corresponding to the to-be-rendered object includes steps F1 to F3.

In step F1, based on camera parameter information corresponding to the target viewpoint, multiple reference spatial points in a three-dimensional space projected onto the same target pixel point are determined.

In step F2, based on the target color information and the volume densities corresponding to the multiple reference spatial points, a pixel color of the target pixel point is determined.

In step F3, based on pixel colors of multiple target pixel points, the rendered image is generated.

In some embodiment, based on camera parameter information corresponding to the target viewpoint, multiple reference spatial points in a three-dimensional space projected onto the same target pixel point can be determined. For example, based on the camera parameter information corresponding to the target viewpoint, multiple camera emission lines can be generated, and each camera emission line corresponds to a pixel point on the rendered image. Multiple reference spatial points located on the same camera emission line are multiple reference spatial points projected onto the same target pixel point.

For each camera emission line, the volume densities and pieces of target color information of the multiple reference spatial points located on the camera emission line are integrated to obtain the pixel color of the pixel point corresponding to the camera emission line. Further, the rendered image is generated based on the pixel color of the pixel point corresponding to each camera emission line. That is, based on pixel colors of multiple target pixel points, the rendered image is generated.

In a manner, after the rendered image is generated, the method further includes: obtaining rendered images corresponding to the to-be-rendered object under the multiple target viewpoints; and generating rendered videos corresponding to the to-be-rendered object based on the multiple rendered images.

In some embodiments, for each of the multiple target viewpoints, steps S101-S104 can be used to generate a rendered image corresponding to the target viewpoint. Further the rendered images corresponding to each of the multiple target viewpoints can be obtained. Then based on the multiple rendered images, a rendered video corresponding to the to-be-rendered object is generated. The rendered video can be a free-view video.

Here, for each to-be-rendered user, a rendered image from any target viewpoint corresponding to the to-be-rendered user can be generated, which is more efficient in generating rendered images, and then based on the multiple rendered images, it is easier to generate a rendered video corresponding to the to-be-rendered object, which improves the efficiency of generating free-view videos. The process does not depend on the external environment, and the free-view video is generated in an easier way.

In a manner, after the rendered image is generated, the method further includes: obtaining rendered images corresponding to the to-be-rendered object under the multiple target viewpoints; based on the rendered images, generating a virtual model corresponding to the to-be-rendered object; and controlling the target device to display the virtual model corresponding to the to-be-rendered object.

In some embodiments, after the rendered image corresponding to each target viewpoint is generated, each rendered image can be subjected to three-dimensional key point extraction to obtain three-dimensional key point information of the to-be-rendered object in each rendered image. Then, the virtual model of the to-be-rendered object can be generated based on the extracted three-dimensional key point information of each rendered image. The target device can be controlled to display the virtual model. The target device can include, for example, a mobile phone, a tablet, an AR device, a VR device, a display screen, and the like.

Here, for each to-be-rendered user, a rendered image can be generated for the to-be-rendered user corresponding to any target viewpoint, and the generation of the rendered image is more efficient. Then based on multiple rendered images, a virtual model corresponding to the to-be-rendered object can be generated more accurately and efficiently.

The rendered image is generated using a trained target neural network. The target neural network can be trained based on a constructed target dataset. The target dataset includes video data from different viewpoints of each of multiple sample users, and a sample parameterized model for each sample user.

The target dataset is constructed according to the following steps G1 to G3.

In step G1, video data of each of the multiple sample users is respectively captured by multiple image capture devices, where different sample users correspond to different user attribute information, the user attribute information includes at least one of: body type, clothing, accessory, hairstyle or motion.

In step G2, based on the video data corresponding to each of the multiple sample users, a sample parameterized model corresponding to each of the multiple sample users is generated.

In step G3, based on the video data and the sample parameterized model corresponding to each of the multiple sample users, the target dataset is constructed.

For example, multiple image capture devices can be set up in a target place, and in response to the presence of a sample user in the target place, the multiple image capture devices are controlled to synchronously acquire the video data of the sample user. Each of the capture devices acquires video data of the sample user from a different sampling viewpoint.

Different sample users correspond to different user attribute information, the user attribute information includes at least one of: body type, clothing, accessory, hairstyle or motion. For example, users of different body types can be selected as multiple sample users. Alternatively, the same sample user may perform different actions in the target place, so as to collect video data of the sample user when performing different actions.

Further, based on the video data corresponding to each of the multiple sample users, a sample parameterized model corresponding to each of the multiple sample users is generated. For example, for each video data of the sample user, a foreground human segmentation is performed for each video frame in the video data to obtain a segmented image corresponding to the video frame. Then three-dimensional key point detection is performed on the segmented image to get the three-dimensional key points of the sample user on the video frame. That is, the three-dimensional key points corresponding to each video frame in the video data are obtained. Then, the three-dimensional key points of each video data corresponding to the sample user can be used to construct the sample parameterization model corresponding to the sample user.

For example, the SMPLx model can be used to generate the sample parameterized model corresponding to the sample user based on multiple pieces of video data corresponding to the sample user.

The target dataset can be constructed using any of the video frames in each video data, and the sample parameterized model corresponding to the sample user. Alternatively, the target dataset can be constructed using the video data and the sample parameterized model corresponding to the sample user.

In the above embodiments, a target dataset with richer samples can be constructed. The target dataset can be used to train the target neural network more accurately, which improves the performance of the trained target neural network.

For example, the target neural network can be obtained by using the target dataset and the synthetic dataset to train the neural network to be trained. The synthetic dataset includes the labelled depth value and the labelled volume density corresponding to each spatial point from the sampling viewpoint.

The neural network can be obtained by training according to the following steps H1 to H6.

In step H1, a training sample in the synthetic dataset is input to the neural network to be trained to generate a first predicted image. The process of generating the first predicted image can be referred to the process of S101 to S104.

In step H2, based on the first predicted image and a first ground truth image corresponding to the first predicted image, a first loss value is generated.

In step H3, the first loss value is used to train the neural network to be trained for multiple rounds until the first training cutoff condition is met, and an intermediate neural network is obtained. The first training cutoff condition includes the first loss value of the neural network being less than the first threshold, or the number of training being equal to the first number threshold, etc.

In step H4, the training sample from the target dataset is then input to the intermediate neural network to generate the second predicted image.

In step H5, based on the second predicted image and a second ground truth image corresponding to the second predicted image, a second loss value is generated.

In step H6, the second loss value is used to train the intermediate neural network for multiple rounds until the second training cutoff condition is met, and the target neural network is obtained. The second training cutoff condition includes the neural network converging, or the number of trainings being equal to the second number threshold, or the second loss value of the neural network being less than the second threshold, etc.

Since the synthetic dataset includes the labelled depth value and labelled volume density corresponding to the spatial point, the first loss value may include an image loss value used to present the color deviation of the image, and a spatial point loss value used to present density deviation and the depth deviation of the spatial point. Since the target dataset does not include the labelled depth value and the labelled volume density corresponding to the spatial point, the second loss value may include the image loss value.

The image loss value is determined according to the following equation.

$${L}_{photo} = {\sum }_{r ∈ R} [ {‖ {c}_{0} ( r ) - \tilde{c} ( r ) ‖}_{2}^{2} + {‖ c ( r ) - \tilde{c} ( r ) ‖}_{2}^{2} ] / \vert R \vert$$

Lₚₕₒₜₒ is the image loss value, R is the number of camera emission lines, i.e., the number of pixel points in the predicted image, c₀(r) is the predicted color information corresponding to each spatial point on the camera emission line generated by the neural network, \tilde{c}(r) is the ground truth color information corresponding to pixel point r on the ground truth image, and c(r) is the predicted color information corresponding to pixel point r on the predicted image.

The spatial point loss value is determined according to the following equation.

$${L}_{geo} = {\sum }_{r ∈ R} {\sum }_{x ∈ r} {‖ tanh ( σ ( x ) ) - \tilde{sgn} ( x ) ‖}^{2} / \vert X \vert + {\sum }_{r ∈ R} {\sum }_{x ∈ r} {‖ o - ψ ( {z}_{gt} - z ) ‖}^{2} / \vert X \vert$$

L_{geO} is the spatial point loss value, |X| is the number of all spatial points, σ(x) is the predicted volume density corresponding to spatial point x, o is the predicted first parameter representing the visibility of spatial point x, and ψ(z_{gt}−z) is used to represent the ground truth first parameter of the visibility of spatial point x.

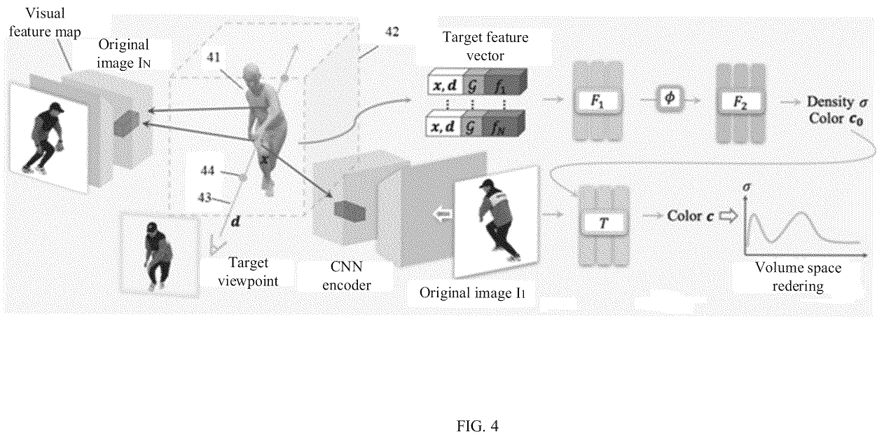

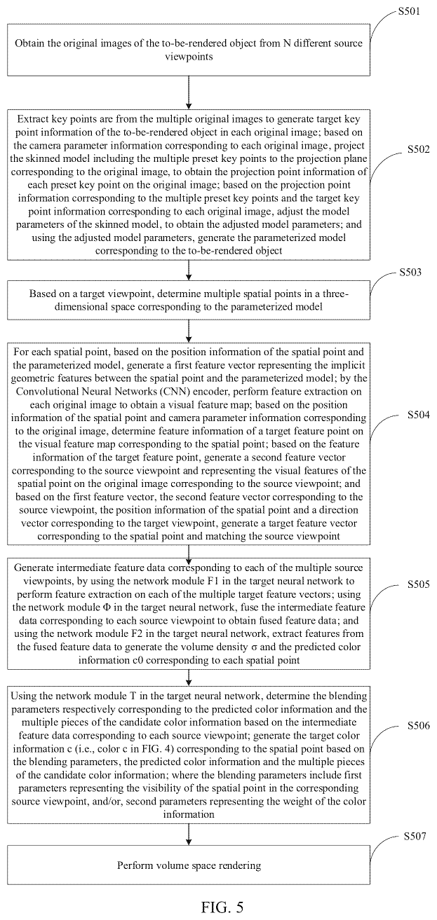

Referring to the structural schematic diagram of the target neural network shown in FIG. 4. An exemplary illustration of the object rendering method is given in conjunction with FIG. 4. Referring to FIG. 5, the method includes the following steps S501 to S507.

In step S501, the original images of the to-be-rendered object from N different source viewpoints are obtained.

For example, the original images I1, . . . , the original image IN, etc. in FIG. 4.

In step S502, key points are extracted from the multiple original images to generate target key point information of the to-be-rendered object in each original image; based on the camera parameter information corresponding to each original image, the skinned model including the multiple preset key points is projected to the projection plane corresponding to the original image, to obtain the projection point information of each preset key point on the original image; based on the projection point information corresponding to the multiple preset key points and the target key point information corresponding to each original image, the model parameters of the skinned model are adjusted, to obtain the adjusted model parameters; and using the adjusted model parameters, the parameterized model corresponding to the to-be-rendered object is generated.

For example, the parameterized model 41 in FIG. 4.

In step S503, based on a target viewpoint, multiple spatial points in a three-dimensional space corresponding to the parameterized model are determined.

For example, the three-dimensional space 42 in FIG. 4, and the multiple spatial points 44 on the camera emission line 43.

In step S504, for each spatial point, based on the position information of the spatial point and the parameterized model, a first feature vector representing the implicit geometric features between the spatial point and the parameterized model is generated. The Convolutional Neural Networks (CNN) encoder is used to perform feature extraction on each original image to obtain a visual feature map. Based on the position information of the spatial point and camera parameter information corresponding to the original image, feature information of a target feature point on the visual feature map corresponding to the spatial point is determined. Based on the feature information of the target feature point, a second feature vector corresponding to the source viewpoint and representing the visual features of the spatial point on the original image corresponding to the source viewpoint is generated. Based on the first feature vector, the second feature vector corresponding to the source viewpoint, the position information of the spatial point and a direction vector corresponding to the target viewpoint, a target feature vector corresponding to the spatial point and matching the source viewpoint is generated.

For example, the target feature vectors in FIG. 4 are (x, d, g, f1), . . . , (x, d, g, fN), x is the position information of the spatial point, d is the direction vector of the target viewpoint, g is the first feature vector, f1 is the second feature vector corresponding to the first source viewpoint, and fN is the second feature vector corresponding to the N-th source viewpoint.

In step S505, intermediate feature data corresponding to each of the multiple source viewpoints is generated, by using the network module F1 in the target neural network to perform feature extraction on each of the multiple target feature vectors. Using the network module Φ in the target neural network, the intermediate feature data corresponding to each source viewpoint can be fused to obtain fused feature data. Using the network module F2 in the target neural network, the fused feature data are feature extracted to generate the volume density σ and the predicted color information c0 corresponding to each spatial point, i.e., density σ and color c0 in FIG. 4.

In step S506, using the network module T in the target neural network, the blending parameters respectively corresponding to the predicted color information and the multiple pieces of the candidate color information are determined based on the intermediate feature data corresponding to each source viewpoint. The target color information c (i.e., color c in FIG. 4) corresponding to the spatial point is generated based on the blending parameters, the predicted color information and the multiple pieces of the candidate color information. The blending parameters include first parameters representing the visibility of the spatial point in the corresponding source viewpoint, and/or, second parameters representing the weight of the color information.

In some embodiments, the first parameter corresponding to each candidate color information is determined according to the following steps: for each source viewpoint, determining the depth information of the spatial point under the source viewpoint based on the position information of the spatial point; based on the intermediate feature data corresponding to the source viewpoint and the depth information of the spatial point under the source viewpoint, generating the first parameter of the candidate color information corresponding to the source viewpoint.

In step S507, volume space rendering is performed.

Specifically based on the camera parameter information corresponding to the target viewpoint, multiple spatial points in the three-dimensional space projected onto the same target pixel point are determined; according to the classical integral rendering formula, the target color information and the volume densities corresponding to the multiple spatial points projected onto the same target pixel point are rendered, to determine the pixel color of the target pixel point; and based on the pixel color of each target pixel point, a rendered image of the to-be-rendered object from the target viewpoint is generated.

Those skilled in the art can understand that in the above method of the embodiments, the writing order of each step does not mean a strict execution order and constitutes any limitation on the implementation process. The specific execution sequence of each step should be determined based on its function and possible internal logic.

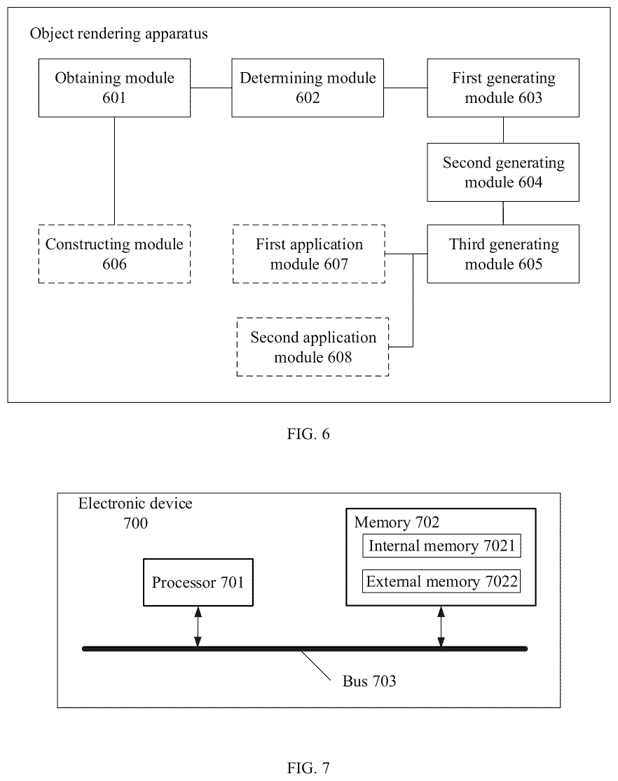

Based on the same idea, in the embodiments of the present disclosure, an object rendering apparatus is further provided. Referring to FIG. 6, a schematic structural diagram of an object rendering apparatus according to embodiments of the present disclosure, the apparatus includes an obtaining module 601, a determining module 602, a first generating module 603, a second generating module 604, and a third generating module 605.

The obtaining module 601 is configured to obtain a parameterized model corresponding to a to-be-rendered object, where the parameterized model is constructed from pre-obtained multiple original images, and the multiple original images are images of the to-be-rendered object respectively captured at different multiple source viewpoints.

The determining module 602 is configured to, based on a target viewpoint, determine multiple spatial points in a three-dimensional space corresponding to the parameterized model.

The first generating module 603 is configured to, for each of the multiple source viewpoints, based on position information of the spatial point, the parameterized model and the multiple original images, generate a target feature vector corresponding to the spatial point and matching the source viewpoint, where the target feature vector includes a visual feature of the spatial point at the corresponding source viewpoint.

The second generating module 604 is configured to, based on multiple target feature vectors corresponding to the spatial point and candidate color information of a projection point of the spatial point on each of the multiple original images, generate volume density and target color information corresponding to the spatial point.

The third generating module 605 is configured to, based on volume densities and target color information respectively corresponding to the multiple spatial points, generate a rendered image of the to-be-rendered object from the target viewpoint.

In a possible embodiment, the obtaining module 601, when generating, based on the multiple original images, a parameterized model corresponding to the to-be-rendered object, is further configured to:

obtain target key point information corresponding to the to-be-rendered object in the original image, by performing key point extraction on the original image;

obtain information on projection points of multiple preset key points of a skinned model on the original image, by projecting the skinned model including the multiple preset key points onto a projection plane corresponding to the original image based on camera parameter information corresponding to the original image;

obtain adjusted model parameters, by adjusting model parameters of the skinned model based on the information on the projection points corresponding to the multiple preset key points and the target key point information corresponding to each the original image; and

based on the adjusted model parameters, generate the parameterized model corresponding to the to-be-rendered object.

In a possible embodiment, the first generating module 603, when based on the position information of the spatial point, the parameterized model and the multiple original images, generating the target feature vector corresponding to the spatial point and matching the source viewpoint, is further configured to;

based on the position information of the spatial point and the parameterized model, generate a first feature vector corresponding to the spatial point; and

generate, based on the position information of the spatial point and the original image corresponding to the source perspective, a second feature vector corresponding to the source perspective; where, the first feature vector is configured to represent an implicit geometric feature between the spatial point and the parameterized model, and the second feature vector is configured to represent a visual feature for the spatial point on the original image corresponding to the source viewpoint; and

based on at least one of the first feature vector, the second feature vector corresponding to the source viewpoint, the position information of the spatial point or a direction vector corresponding to the target viewpoint, generate a target feature vector corresponding to the spatial point and matching the source viewpoint.

In a possible embodiment, the first generating module 603, when generating the first feature vector corresponding to the spatial point, based on the position information of the spatial point and the parameterized model, is further configured to:

based on the position information of the spatial point, determine a target model point on the parameterized model with the smallest distance from the spatial point:

based on the position information of the spatial point and position information of the target model point, determine distance information and direction information of the spatial point relative to the parameterized model;

based on a mapping relationship between a first model point on the parameterized model and a second model point on a canonical model, determine position information of a second model point corresponding to the target model point; and

based on at least one of the distance information, the direction information or the position information of the second model point corresponding to the target model point, generate the first feature vector corresponding to the spatial point.

In a possible embodiment, the first generating module 603, when based on the position information of the spatial point and the original image corresponding to the source viewpoint, generating a second feature vector corresponding to the source viewpoint, is further configured to:

generate a visual feature map for the original image corresponding to the source viewpoint, by performing feature extraction on the original image;

based on the position information of the spatial point and camera parameter information corresponding to the original image, determine feature information of a target feature point on the visual feature map corresponding to the spatial point; and

based on the feature information of the target feature point, generate the second feature vector corresponding to the source viewpoint.

In a possible embodiment, the second generating module 604, when based on multiple target feature vectors corresponding to the spatial point and candidate color information of a projection point of the spatial point on each of the multiple original images, generating volume density and target color information corresponding to the spatial point, is further configured to:

generate intermediate feature data corresponding to each of the multiple source viewpoints, by performing feature extraction on each of the multiple target feature vectors:

based on the intermediate feature data corresponding to the multiple source viewpoints, generate the volume density and predicted color information corresponding to the spatial point; and

based on the predicted color information and the candidate color information of the projection point of the spatial point on each of the multiple original images, generate the target color information corresponding to the spatial point.

In a possible embodiment, the second generating module 604, when based on the predicted color information and the candidate color information of the projection point of the spatial point on each of the multiple original images, generating the target color information corresponding to the spatial point, is further configured to:

determine blending parameters corresponding to the predicted color information and the candidate color information corresponding to each of the multiple original images, where the blending parameters include at least one of; a first parameter representing visibility of the spatial point from a corresponding source viewpoint, or a second parameter representing a weight of color information; and

generate the target color information corresponding to the spatial point, by performing blending process on the predicted color information and the candidate color information corresponding to each of the multiple original images according to the blending parameters.

In a possible embodiment, the blending parameters include the first parameters, and the second generating module 604 determines the first parameters corresponding to the predicted color information and the multiple pieces of candidate color information according to the following steps:

based on a preset value, determining the first parameter corresponding to the predicted color information;

for each of the multiple source viewpoints, determining depth information of the spatial point from the source viewpoint based on the position information of the spatial point; and

based on the intermediate feature data corresponding to the source viewpoint and the depth information of the spatial point from the source viewpoint, generating the first parameter of the candidate color information corresponding to the source viewpoint.

In a possible embodiment, the blending parameters include the second parameters, and the second generating module 603 determines the second parameters respectively corresponding to the predicted color information and the multiple pieces of candidate color information according to the following steps.

obtaining fused feature data, by performing fusing process on the intermediate feature data corresponding to each of the multiple source viewpoints;

generating key information based on a first target feature data and a second target feature data; and generating query information based on the first target feature data; where the first target feature data includes the fused feature data, the direction vector of the target viewpoint and the position information of the spatial point; the second target feature data includes the intermediate feature data corresponding to each of the multiple source viewpoints, direction vectors of the multiple source viewpoints and the position information of the spatial points, the key information represents feature information of the predicted color information and the candidate color information corresponding to each of the multiple original images; and the query information represents feature information of the predicted color information; and

based on the key information and the query information, determining the second parameters corresponding to the candidate color information corresponding to each of the multiple original images and the predicted color information.

In a possible embodiment, the third generating module 605, when based on volume densities and target color information respectively corresponding to the multiple spatial points, generating a rendered image of the to-be-rendered object from the target viewpoint, is further configured to:

based on camera parameter information corresponding to the target viewpoint, determine multiple reference spatial points in a three-dimensional space projected onto a target pixel point;

based on the target color information and the volume densities corresponding to the multiple reference spatial points, determine pixel color of the target pixel point; and

based on pixel colors of multiple target pixel points, generate the rendered image.

In a possible embodiment, the rendered image is generated by a trained target neural network, the target neural network is trained based on a constructed target dataset, the target dataset includes video data from different viewpoints corresponding to each of multiple sample users and a sample parameterized model corresponding to each of the multiple sample users.

The apparatus further includes a constructing module 606, configured to construct the target dataset according to the following steps:

respectively capturing video data of each of the multiple sample users by multiple image capture devices, where different sample users correspond to different user attribute information, the user attribute information includes at least one of: body type, clothing, accessory, hairstyle or motion;

based on the video data corresponding to each of the multiple sample users, generating a sample parameterized model corresponding to each of the multiple sample users; and

based on the video data and the sample parameterized model corresponding to each of the multiple sample users, constructing the target dataset.

In a possible embodiment, the apparatus further includes a first application module 607, configured to, after the rendered image is generated,

obtain multiple rendered images corresponding to the to-be-rendered object from multiple target viewpoints; and

based on the multiple rendered images, generate a rendered video corresponding to the to-be-rendered object.

In a possible embodiment, the apparatus further includes a second application module 608, configured to, after the rendered image is generated,

obtain multiple rendered images corresponding to the to-be-rendered object from multiple target viewpoints; and

based on the multiple rendered images, generate a virtual model corresponding to the to-be-rendered object; and

controlling a target device to display the virtual model corresponding to the to-be-rendered object.

In some embodiments, the functions or modules of the apparatus provided in the embodiments of the present disclosure can be configured to execute the methods described in the above method embodiments, and its embodiments can refer to the descriptions of the above method embodiments. For the sake of brevity, no more details are given here.

Based on the same technical idea, an embodiment of the present disclosure further provides an electronic device. Referring to FIG. 7, a schematic structural diagram of an electronic device provided by some embodiments of the present disclosure, the electronic device includes a processor 701, a memory 702, and a bus 703. The memory 702 is configured to store execution instructions, including an internal memory 7021 and an external memory 7022. The internal memory 7021 is configured to temporarily store calculation data in the processor 701 and exchange data with the external memory 7022 such as a hard disk. The processor 701 exchanges data with the external memory 7022 through the internal memory 7021. When the electronic device 700 is running, the processor 701 communicates with the memory 702 through the bus 703, such that the processor 701 executes the following instructions:

obtaining a parameterized model corresponding to a to-be-rendered object, where the parameterized model is constructed from pre-obtained multiple original images, and the multiple original images are images of the to-be-rendered object respectively captured at different multiple source viewpoints;

based on the target viewpoint, determining a plurality of spatial points from the three-dimensional space corresponding to the parameterized model, for each of the multiple source viewpoints, based on position information of the spatial point, the parameterized model and the multiple original images, generating a target feature vector corresponding to the spatial point and matching the source viewpoint, where the target feature vector includes a visual feature of the spatial point at the corresponding source viewpoint; and

based on multiple target feature vectors corresponding to the spatial point and candidate color information of a projection point of the spatial point on each of the multiple original images, generating volume density and target color information corresponding to the spatial point; and

based on volume densities and target color information respectively corresponding to the multiple spatial points, generating a rendered image of the to-be-rendered object from the target viewpoint.

For the specific processing flow of the processor 701, reference may be made to the descriptions in the foregoing method embodiments, and details are not repeated here.

In addition, in an embodiment of the present disclosure a computer-readable storage medium is further provided, a computer program is stored on the computer-readable storage medium, and when the computer program is run by a processor, the steps of the object rendering method described in the above-mentioned method embodiments are executed. The storage medium may be a volatile or non-volatile computer-readable storage medium.

In embodiments of the present disclosure, a computer program product is further provided, the computer program product carries a program code, and instructions included in the program code can be configured to execute the steps of the object rendering method described in the above method embodiment, for details, reference can be made to the above method embodiments, and details are not repeated here.

The computer program product can be implemented by hardware, software or a combination thereof. In some embodiments, the computer program product is embodied as a computer storage medium. In some embodiments, the computer program product is embodied as a software product, such as a Software Development Kit (SDK) and so on.

The present disclosure relates to the field of augmented reality. By acquiring the image information of the target object in the real environment, and then using various algorithms related to vision to detect or identify the relevant features, states and attributes of the target object, the AR effect of combining virtual and reality that matches the specific application can be obtained. For example, the target object may involve faces, limbs, gestures, motions, etc., or signs and markers related to objects, or sand tables, display areas or display items related to venues or places. Vision-related algorithms can involve visual positioning, SLAM, 3D reconstruction, image registration, background segmentation, object key point extraction and tracking, object pose or depth detection, etc. Specific applications can not only involve interactive scenes such as guided tours, navigation, explanations, reconstructions, virtual effect overlays and display related to real scenes or objects, but also special effects processing related to people, such as makeup beautification, body beautification, special effect display, virtual model display and other interactive scenes. The relevant features, states and attributes of the target object can be detected or identified through the convolutional neural network. The above-mentioned convolutional neural network is a network model obtained by performing model training based on a deep learning framework.

In the embodiments provided in the present disclosure, free-view videos in a less viewing angle environment can be generated. The usage scenarios of the embodiments of the disclosure include immersive remote video. In this usage scenario, the user can remotely conduct immersive video conferencing with others in a camera environment with four viewpoints. Only through the above cameras with four viewpoints, the other party can observe the user from any viewpoint and make video conference with the user from any viewpoint. The use scenarios of the embodiments of the present disclosure also include VR or AR scene interaction. Since the embodiments of the present disclosure can also dynamically obtain the user's 3D model, it can perform real rendering and interaction with objects in the VR or AR scene.

Those skilled in the art can clearly understand that for the convenience and brevity of description, the specific working process of the above-described system and device can refer to the corresponding process in the foregoing method embodiments, which will not be repeated here. In several examples provided by the present disclosure, it should be understood that the disclosed systems, apparatuses and methods may be implemented in other ways. The apparatus examples described above are merely schematic, for example, the division of the units is merely a logical function division, and there may be another division manner in actual embodiment, for example, multiple units or components may be combined, or may be integrated into another system, or some features may be ignored or not performed. In another point, the mutual coupling or direct coupling or communication connection shown or discussed may be through some communication interfaces, and the indirect coupling or communication connection of devices or units may be in electrical, mechanical or other forms.

The units described as separate members may be or not be physically separated, and the members displayed as units may be or not be physical units, i.e., may be located in one place, or may be distributed to a plurality of network units. Part or all of the modules may be selected according to actual requirements to implement the objectives of the solutions in the examples.

In addition, each functional unit in each embodiment of the present disclosure may be integrated into one processing unit, each unit may exist separately physically, or two or more units may be integrated into one unit.

If the functions are realized in the form of software function units and sold or used as independent products, they can be stored in a non-volatile computer-readable storage medium executable by a processor. Based on this understanding, the technical solution of the present disclosure is embodied in the form of a software product in essence or in a part that contributes to the prior art or in a part of the technical solution. The computer software product is stored in a storage medium, including some instructions than can cause a computer device (which can be a personal computer, a server, or a network device, etc.) to perform all or part of the steps of the method described in each example of the present invention. The storage medium includes: a U disk, a mobile hard disk, a read-only memory (ROM), a random-access memory (RAM), a magnetic disk or an optical disk and other media that can store program codes.

If the technical solution of this application involves personal information, the product applying the technical solution of this application has clearly notified the personal information processing rules and obtained the individual's independent consent before processing personal information. If the technical solution of this application involves sensitive personal information, the products applying the technical solution of this application have obtained individual consent before processing sensitive personal information, and at the same time meet the requirements of “express consent”. For example, at a personal information collection device such as a camera, a clear and prominent sign is set up to inform that it has entered the scope of personal information collection, and personal information will be collected. If people individual voluntarily enters the collection scope, it is deemed to agree to the collection of personal information; or on the personal information processing device, when the personal information processing rules are informed with obvious signs/information, personal authorization is obtained through pop-up information or by asking individuals to upload personal information: the personal information processing rules may include Information processor, purpose of personal information processing, processing method, type of personal information processed and other information.

The foregoing description is merely a specific embodiment of the present disclosure, but the scope of protection of the present disclosure is not limited thereto, and any variation or replacement readily conceivable by a person skilled in the art within the technical scope disclosed in the present disclosure should belong to the scope of protection of the present disclosure. Therefore, the scope of protection of the present disclosure should be based on the scope of protection of said claims.

What is claimed is:

1. A method of object rendering, comprising:
obtaining a parameterized model corresponding to a to-be-rendered object, wherein the parameterized model is constructed from pre-obtained multiple original images, and the multiple original images comprise images of the to-be-rendered object respectively captured at multiple source viewpoints;
based on a target viewpoint, determining multiple spatial points in a three-dimensional space corresponding to the parameterized model;
for each of the multiple spatial points,
for each of the multiple source viewpoints, based on position information of the spatial point, the parameterized model and the multiple original images, generating a target feature vector corresponding to the spatial point and matching the source viewpoint, wherein the target feature vector comprises a visual feature of the spatial point at the source viewpoint; and
based on multiple target feature vectors corresponding to the spatial point and candidate color information of a projection point of the spatial point on each of the multiple original images, generating volume density and target color information corresponding to the spatial point; and
based on volume densities and target color information respectively corresponding to the multiple spatial points, generating a rendered image of the to-be-rendered object under the target viewpoint.

2. The method according to claim 1, wherein, based on the position information of the spatial point, the parameterized model and the multiple original images, generating the target feature vector corresponding to the spatial point and matching the source viewpoint comprises:
based on the position information of the spatial point and the parameterized model, generating a first feature vector corresponding to the spatial point, wherein the first feature vector is configured to represent an implicit geometric feature between the spatial point and the parameterized model;
based on the position information of the spatial point and an original image corresponding to the source viewpoint, generating a second feature vector corresponding to the source viewpoint, wherein the second feature vector is configured to represent a visual feature for the spatial point in the original image corresponding to the source viewpoint; and
based on at least one of the first feature vector, the second feature vector corresponding to the source viewpoint, the position information of the spatial point, or a direction vector corresponding to the target viewpoint, generating the target feature vector corresponding to the spatial point and matching the source viewpoint.

3. The method according to claim 2, wherein, based on the position information of the spatial point and the parameterized model, generating the first feature vector corresponding to the spatial point comprises:
based on the position information of the spatial point, determining a target model point on the parameterized model with a smallest distance under the spatial point;
based on the position information of the spatial point and position information of the target model point, determining distance information and direction information of the spatial point relative to the parameterized model;
based on a mapping relationship between a first model point on the parameterized model and a second model point on a canonical model, determining position information of the second model point corresponding to the target model point; and
based on at least one of the distance information, the direction information, or the position information of the second model point corresponding to the target model point, generating the first feature vector corresponding to the spatial point.

4. The method according to claim 2, wherein, based on the position information of the spatial point and the original image corresponding to the source viewpoint, generating the second feature vector corresponding to the source viewpoint comprises:
generating a visual feature map for the original image corresponding to the source viewpoint by performing feature extraction on the original image;
based on the position information of the spatial point and camera parameter information corresponding to the original image, determining feature information of a target feature point on the visual feature map corresponding to the spatial point; and
based on the feature information of the target feature point, generating the second feature vector corresponding to the source viewpoint.

5. The method according to claim 1, wherein, based on the multiple target feature vectors corresponding to the spatial point and the candidate color information of the projection point of the spatial point on each of the multiple original images, generating the volume density and the target color information corresponding to the spatial point comprises:
generating intermediate feature data corresponding to each of the multiple source viewpoints by performing feature extraction on each of the multiple target feature vectors;
based on the intermediate feature data corresponding to the multiple source viewpoints, generating the volume density and predicted color information corresponding to the spatial point; and
based on the predicted color information and the candidate color information of the projection point of the spatial point on each of the multiple original images, generating the target color information corresponding to the spatial point.

6. The method according to claim 5, wherein, based on the predicted color information and the candidate color information of the projection point of the spatial point on each of the multiple original images, generating the target color information corresponding to the spatial point comprises:
determining blending parameters corresponding to the predicted color information and the candidate color information corresponding to each of the multiple original images, wherein the blending parameters comprise at least one of: a first parameter representing visibility of the spatial point from a corresponding source viewpoint, or a second parameter representing a weight of color information; and
generating the target color information corresponding to the spatial point by performing a blending process on the predicted color information and the candidate color information corresponding to each of the multiple original images according to the blending parameters.

7. The method according to claim 6, wherein the blending parameters comprise the first parameter, and wherein determining the blending parameters corresponding to the predicted color information and the candidate color information corresponding to each of the multiple original images comprises:
based on a preset value, determining the first parameter corresponding to the predicted color information;
for each of the multiple source viewpoints, determining depth information of the spatial point under the source viewpoint based on the position information of the spatial point; and
based on the intermediate feature data corresponding to the source viewpoint and the depth information of the spatial point from the source viewpoint, generating the first parameter of the candidate color information corresponding to the source viewpoint.

8. The method according to claim 6, wherein the blending parameters comprise the second parameter, and wherein determining the blending parameters corresponding to the predicted color information and the candidate color information corresponding to each of the multiple original images comprises:
obtaining fused feature data by performing a fusing process on the intermediate feature data corresponding to each of the multiple source viewpoints;
generating key information based on first target feature data and second target feature data; wherein the first target feature data comprises the fused feature data, the direction vector of the target viewpoint and the position information of the spatial point, wherein the second target feature data comprises the intermediate feature data corresponding to each of the multiple source viewpoints, direction vectors of the multiple source viewpoints and the position information of the spatial points, and wherein the key information represents feature information of the predicted color information and the candidate color information corresponding to each of the multiple original images;
generating query information based on the first target feature data, wherein the query information represents feature information of the predicted color information; and
based on the key information and the query information, determining the second parameters corresponding to the candidate color information corresponding to each of the multiple original images and the predicted color information.

9. The method according to claim 1, wherein obtaining the parameterized model corresponding to the to-be-rendered object comprises:
for each of the multiple original images,
obtaining target key point information corresponding to the to-be-rendered object in the original image by performing key point extraction on the original image; and
obtaining information on projection points of multiple preset key points of a skinned model on the original image by projecting the skinned model comprising the multiple preset key points onto a projection plane corresponding to the original image based on camera parameter information corresponding to the original image;
obtaining adjusted model parameters, by adjusting model parameters of the skinned model based on the information on the projection points corresponding to the multiple preset key points and the target key point information corresponding to each of the multiple original images; and
based on the adjusted model parameters, generating the parameterized model corresponding to the to-be-rendered object.

10. The method according to claim 1, wherein, based on the volume densities and the target color information respectively corresponding to the multiple spatial points, generating the rendered image of the to-be-rendered object under the target viewpoint comprises:
based on camera parameter information corresponding to the target viewpoint, determining multiple reference spatial points in a three-dimensional space projected onto a target pixel point;
based on the target color information and the volume densities corresponding to the multiple reference spatial points, determining pixel color of the target pixel point; and
based on pixel colors of multiple target pixel points, generating the rendered image.

11. The method according to claim 1, wherein the rendered image is generated by a trained target neural network that is trained based on a constructed target dataset, wherein the target dataset comprises video data from different viewpoints corresponding to multiple sample users and a respective sample parameterized model corresponding to each of the multiple sample users, and
wherein the target dataset is constructed by:
respectively capturing video data of each of the multiple sample users by multiple image capture devices, wherein different sample users correspond to different user attribute information, the user attribute information comprises at least one of: body type, clothing, accessory, hairstyle, or motion;
based on the video data corresponding to each of the multiple sample users, generating the respective sample parameterized model corresponding to each of the multiple sample users; and
based on the video data and the respective sample parameterized model corresponding to each of the multiple sample users, constructing the target dataset.

12. The method according to claim 1, wherein, after generating the rendered image, the method further comprises:
obtaining multiple rendered images corresponding to the to-be-rendered object from multiple target viewpoints; and
based on the multiple rendered images, generating a rendered video corresponding to the to-be-rendered object.

13. The method according to claim 1, wherein, after generating the rendered image, the method further comprises:
obtaining multiple rendered images corresponding to the to-be-rendered object under multiple target viewpoints;
based on the multiple rendered images, generating a virtual model corresponding to the to-be-rendered object; and
controlling a target device to display the virtual model corresponding to the to-be-rendered object.

14. An electronic device, comprising:
at least one processor;
at least one memory; and
a bus,
wherein the at least one memory stores machine-readable instructions executable by the at least one processor, the at least one processor communicates with the at least one memory via the bus when the electronic device is in operation, and when the machine-readable instructions are executed by the at least one processor, the at least one processor is caused to perform actions comprising:
obtaining a parameterized model corresponding to a to-be-rendered object, wherein the parameterized model is constructed from pre-obtained multiple original images, and the multiple original images comprise images of the to-be-rendered object respectively captured at multiple source viewpoints;
based on a target viewpoint, determining multiple spatial points in a three-dimensional space corresponding to the parameterized model;
for each of the multiple spatial points,
for each of the multiple source viewpoints, based on position information of the spatial point, the parameterized model, and the multiple original images, generating a target feature vector corresponding to the spatial point and matching the source viewpoint, wherein the target feature vector comprises a visual feature of the spatial point at the source viewpoint; and
based on multiple target feature vectors corresponding to the spatial point and candidate color information of a projection point of the spatial point on each of the multiple original images, generating volume density and target color information corresponding to the spatial point; and
based on volume densities and target color information respectively corresponding to the multiple spatial points, generating a rendered image of the to-be-rendered object under the target viewpoint.

15. The electronic device according to claim 14, wherein, based on the position information of the spatial point, the parameterized model and the multiple original images, generating the target feature vector corresponding to the spatial point and matching the source viewpoint comprises:
based on the position information of the spatial point and the parameterized model, generating a first feature vector corresponding to the spatial point, wherein the first feature vector is configured to represent an implicit geometric feature between the spatial point and the parameterized model;
based on the position information of the spatial point and an original image corresponding to the source viewpoint, generating a second feature vector corresponding to the source viewpoint, wherein the second feature vector is configured to represent a visual feature for the spatial point on the original image corresponding to the source viewpoint; and
based on at least one of the first feature vector, the second feature vector corresponding to the source viewpoint, the position information of the spatial point or a direction vector corresponding to the target viewpoint, generating the target feature vector corresponding to the spatial point and matching the source viewpoint.

16. The electronic device according to claim 15, wherein, based on the position information of the spatial point and the parameterized model, generating the first feature vector corresponding to the spatial point comprises:
based on the position information of the spatial point, determining a target model point on the parameterized model with a smallest distance from the spatial point;
based on the position information of the spatial point and position information of the target model point, determining distance information and direction information of the spatial point relative to the parameterized model;
based on a mapping relationship between a first model point on the parameterized model and a second model point on a canonical model, determining position information of the second model point corresponding to the target model point; and
based on at least one of the distance information, the direction information or the position information of the second model point corresponding to the target model point, generating the first feature vector corresponding to the spatial point.

17. The electronic device according to claim 15, wherein, based on the position information of the spatial point and the original image corresponding to the source viewpoint, generating the second feature vector corresponding to the source viewpoint comprises:
generating a visual feature map for the original image corresponding to the source viewpoint, by performing feature extraction on the original image;
based on the position information of the spatial point and camera parameter information corresponding to the original image, determining feature information of a target feature point on the visual feature map corresponding to the spatial point; and
based on the feature information of the target feature point, generating the second feature vector corresponding to the source viewpoint.

18. The electronic device according to claim 14, wherein, based on the multiple target feature vectors corresponding to the spatial point and the candidate color information of the projection point of the spatial point on each of the multiple original images, generating the volume density and the target color information corresponding to the spatial point comprises:
generating intermediate feature data corresponding to each of the multiple source viewpoints by performing feature extraction on each of the multiple target feature vectors;
based on the intermediate feature data corresponding to the multiple source viewpoints, generating the volume density and predicted color information corresponding to the spatial point; and
based on the predicted color information and the candidate color information of the projection point of the spatial point on each of the multiple original images, generating the target color information corresponding to the spatial point.

19. The electronic device according to claim 18, wherein, based on the multiple target feature vectors corresponding to the spatial point and the candidate color information of the projection point of the spatial point on each of the multiple original images, generating the volume density and the target color information corresponding to the spatial point comprises:
determining blending parameters corresponding to the predicted color information and the candidate color information corresponding to each of the multiple original images, wherein the blending parameters comprise at least one of; a first parameter representing visibility of the spatial point under a corresponding source viewpoint or a second parameter representing a weight of color information; and
generating the target color information corresponding to the spatial point, by performing blending process on the predicted color information and the candidate color information corresponding to each of the multiple original images according to the blending parameters.

20. A non-transitory computer-readable storage medium storing one or more computer programs executable by at least one processor to perform operations comprising:
obtaining a parameterized model corresponding to a to-be-rendered object, wherein the parameterized model is constructed from pre-obtained multiple original images, and the multiple original images comprise images of the to-be-rendered object respectively captured at multiple source viewpoints;
based on a target viewpoint, determining multiple spatial points in a three-dimensional space corresponding to the parameterized model;
for each of the multiple spatial points,
for each of the multiple source viewpoints, based on position information of the spatial point, the parameterized model and the multiple original images, generating a target feature vector corresponding to the spatial point and matching the source viewpoint, wherein the target feature vector comprises a visual feature of the spatial point at the source viewpoint; and
based on multiple target feature vectors corresponding to the spatial point and candidate color information of a projection point of the spatial point on each of the multiple original images, generating volume density and target color information corresponding to the spatial point; and
based on volume densities and target color information respectively corresponding to the multiple spatial points, generating a rendered image of the to-be-rendered object under the target viewpoint.
